(19) United States
(12) Patent Application Publication
(10) Pub. No.: US 2011/0177925 A1
(43) Pub. Date: Jul. 21, 2011

(54) TOOL CHANGER FOR MACHINE TOOLS

(75) Inventors: Matthias Mayr, Füssen (DE); Oliver Kraft, Pfronten (DE)

(73) Assignee: DECKEL MAHO PFRONTEN GMBH, Pfronten (DE)

(21) Appl. No.: 13/003,248

(22) PCT Filed: Jul. 7, 2009
(86) PCT No.: PCT/EP09/04912

§ 371 Date: Apr. 4, 2011

(30) Foreign Application Priority Data
Jul. 7, 2008 (DE) 20 2008 009 035.0

(51) Int. Cl. B23Q 3/155

(52) U.S. Cl. 483/14

(57) ABSTRACT

A tool changer for machine tools, especially for milling machines, with a tool double gripper, which is attached at the free end of an axially displaceable and rotatably mounted shaft and has two pliers-like tool holders. A drive motor is coupled kinematically with the shaft for the linear and rotary movements of the tool double gripper and with transmission means for converting the rotation of the motor shaft of the drive motor into the linear and rotary movements of the tool double gripper. The transmission means contains a worm gear driven by the drive motor, the worm gear drives a cam plate at the front end of which a lifting curve for the linear movement and a rotation curve are constructed. A driver of a rack and pinion drive coupled rotationally with the shaft engages the rotation curve, and a driver of a pivoting linkage translationally coupled with the shaft engages the lifting curve and is guided by it.

### FIELD OF THE INVENTION

The invention relates to a tool changer for machine tools, particularly for milling machines, with a tool double gripper which is attached at the free end of an axially displaceable and rotatably mounted shaft and has two diametrically opposed pliers-like tool holders.

### BACKGROUND

Tool changing devices for machine tools are already known which have a cam plate or a cam barrel. The cam plate contains a lateral herpolhode curve which realizes the lifting of the tool changing device, that is, the advancing movement of the tool double gripper thereof. Furthermore, the cam plate and the cam barrel, respectively, contains a globoid cam at the hull surface thereof, which is engaged by a ball star or roll star displaceably supported on a spline shaft in the axial direction thereof and effects the rotary movement of the tool double gripper. Frequently, a planetary gear is connected between the drive motor and the cam plate or cam barrel. By suitably arranging the above-mentioned components and the herpolhode curves relative to one another, a desired lift-swivel-lift movement of the tool double gripper is generated. However, such tool changing devices are complex and expensive to produce due to the servo drive comprising a planetary gear reduction, the globoid cam comprising the roll star and finally due to the spline shaft profile for superimposing lifting and swiveling movements.

### SUMMARY OF EMBODIMENTS OF THE INVENTION

It is a purpose of embodiments of this invention to provide a tool changer for machine tools, in particular for milling machines, machining centers and the like, which overcomes the deficiencies of the above-mentioned prior art, consists of structurally simple single parts and may be produced with high operational reliability at low cost.

This purpose is achieved according to embodiments of the invention by the fact that the transmission means contain a worm gear driven by a drive motor and driving a cam plate, that a lifting curve and a rotation curve are constructed at the face of the cam plate, that a driver of a rack and pinion drive rotationally coupled with the shaft engages the lifting curve and that a driver of a pivoting linkage translationally coupled with the shaft engages the rotation curve and is guided by it.

According to an advantageous design, the cam plate has the lifting curve at one face thereof and the rotation curve at the other face thereof. In this manner, a space-saving construction is provided because the rack and pinion drive may be arranged at one outer surface of the cam plate and the pivoting linkage may be disposed at the other outer surface of the cam plate. In total, a compact tool changer results which claims only little space at the side between the machine tool and the associated tool magazine.

According to another favorable embodiment, the worm wheel of a worm gear forms a swivel plate and for this purpose has the corresponding teeth on the outer periphery thereof. In terms of aspects of costs a servo direct drive or pole-changing a.c. motor is used as a drive motor according to another suitable design of the invention.

In the tool changer designed according to embodiments of the invention, the advantages of small outer dimensions and low production costs result from structurally simple assemblies in that, for example, the shaft has a toothed portion extending in the longitudinal direction thereof which is engaged by the toothed part of the rack. Thus, the linear movement of the rack will be directly converted into a rotary movement of the shaft doubly mounted in an elongated pipe-like housing.

In order to achieve the axial advancing movement of the shaft and the lifting movement of the tool double gripper, respectively, by using technically simple means, the pivoting linkage suitably has a swiveling lever to which a driving device coupled with the shaft and the driver spaced-apart from the former and engaging the lifting curve of the swivel plate are mounted. In accordance with the course of the lifting curve the swiveling lever performs pivoting movements about its bearing which are converted into translational advancing movements of the shaft. Suitably, the driving device is attached to one end of the swiveling lever and the driver is attached to the other end thereof.

### BRIEF DESCRIPTION OF THE DRAWING

Further purposes, advantages, and particulars of the invention can be taken from the following detailed description with reference to the accompanying drawing, wherein:

FIG. 1 is a perspective view of a milling machine comprising a chain magazine and a tool changer according to an embodiment of the invention;

FIG. 2 shows the tool changer used in the machine of FIG. 1 in a first operational posture in a partially sectional side view;

FIG. 3 shows the tool changer used in the machine of FIG. 1 in a second operational posture in a partially sectional side view;

FIG. 4 shows the tool changer of FIG. 2 in the same operational status in a partially sectional perspective illustration from the other side;

FIG. 5 shows the tool changer of FIG. 3 in the same operational status in a partially sectional perspective illustration from the other side;

FIG. 6 shows another embodiment of the inventive tool changer in a first perspective side view; and

FIG. 7 shows the inventive tool changer of FIG. 6 in a second perspective side view.

### DETAILED DESCRIPTION OF EMBODIMENTS OF THE INVENTION

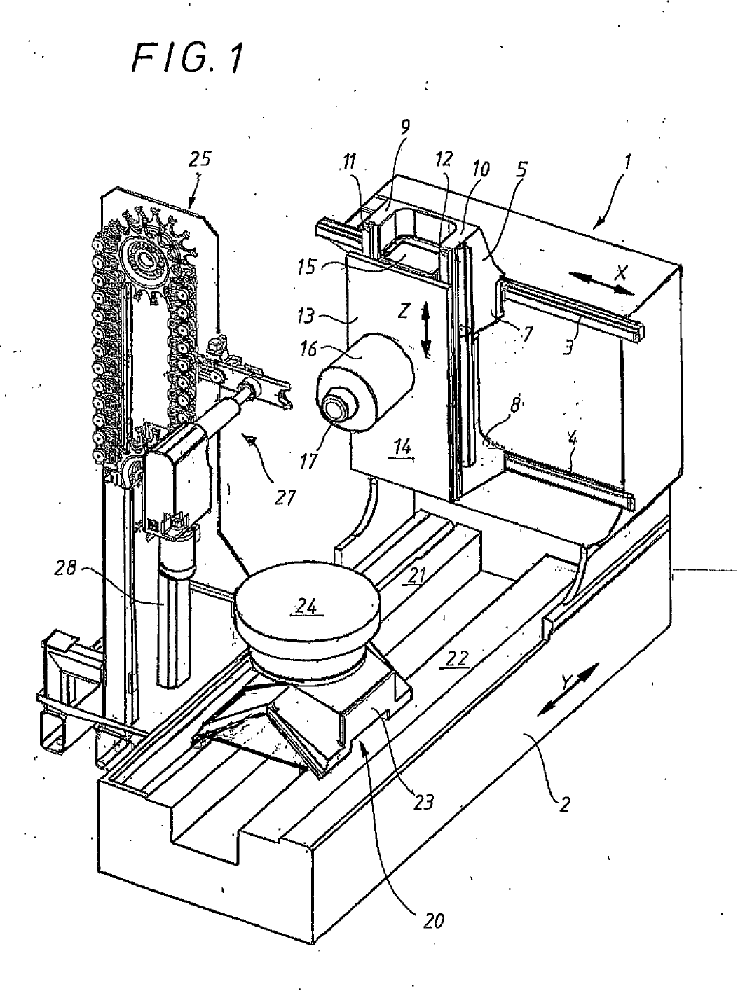

The machine tool shown in FIG. 1 is a program-controlled milling machine of a highly rigid construction having a stand 1 disposed at the rear end of elongated bed 2, to the face of which two parallel guide rails 3, 4 are mounted. Horizontal slide 5 moves along the X coordinate axis on these guide rails. As drive assemblies for the horizontal travel movements of slide 5, spindle drives comprising a ball screw, electric linear motors or other suitable drive assemblies (not shown) may be used. Horizontal slide 5 has two rear guide lugs 7, 8 in which are installed guide shoes running on guide rails 3, 4. As shown, the horizontal slide has a U-shaped opening in the front that imparts high inherent rigidity while keeping the weight low, which effects high dynamics and machining accuracy of the overall machine. Two parallel vertical guide rails 11, 12, on which a vertical slide 13 is displaceably guided in the vertical Z coordinate axis, are attached to front parallel legs 9, 10 of U-shaped horizontal slide 5. As can be seen, vertical slide 13 has front plate member 14 to the rear side of which supporting and guiding member 15 is attached that is engaged between legs 9, 10 of the horizontal slide and possibly guided there separately. Spindle head 16 having tool holder 17 is disposed at the front of vertical slide 13.

On the top side of bed 2 is workpiece table arrangement 20 displaceably guided on parallel guide rails 21, 22 in the direction of the Y coordinate axis. This workpiece table arrangement contains base 23 supported on rails 21, 22 and displaceable in the Y direction by means of, for example, one or more linear motors (not shown), and turntable 24 disposed on base 23.

At the side of the machine tool is tool chain magazine 25, arranged on a support structure. Tool changer 27, designed according to the invention and described below in more detail, is disposed on support structure 28 in the space between the machine tool and the tool magazine.

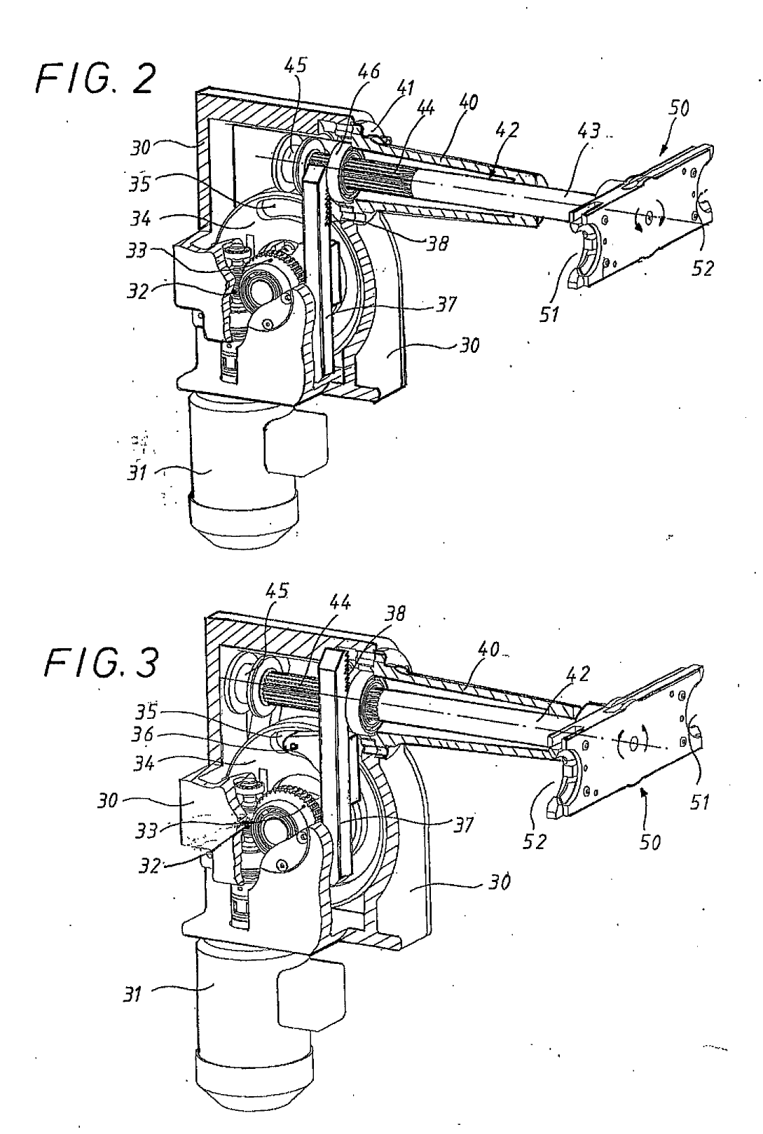

Tool changer 27, shown in FIGS. 2 to 5, includes housing 30 to the bottom wall of which motor 31 is mounted in vertical alignment. Housing 30 is shown partially broken away to reveal the inner structure of the tool changer. Motor 31 drives worm wheel gear 32, 33. For this purpose the motor shaft is coupled with worm 32 engaging the teeth of worm wheel 33 supported about a horizontal shaft. Worm wheel 33 drives swivel plate 34 in one side of which groove-shaped rotation curve 35 is formed. Driver 36 is mounted to rack 37 and is guided in rotation curve 35. Rack 37 is shown having a square cross section. Rack 37 has teeth 38 in the upper end portion thereof and is guided in housing 30 so as to be vertically displaceable. Rotation of swivel plate 34 via the engagement of driver 36 of groove-shaped rotation curve 35 leads to a vertical movement of rack 37. Via the engagement of rack 37 with longitudinally toothed shaft portion 44, the vertical movement of rack 37 results in rotation of shaft 42 and double gripper 50 on the end of that shaft.

Support pipe 40 is supported at one side of the upper part of housing 30 by means of flange 41 at the end so as to be rotatable about the longitudinal axis thereof. Support pipe 40 has a shape gradually tapering toward the distal or free end, that is, a slightly conical shape. The support pipe may also be cylindrical. Shaft 42 is accommodated in support pipe 40 in an axially displaceable manner. Shaft 42 has cylindrical portion 43, longitudinally toothed portion 44, and limiting bushing 45 at the inner or proximal end. Longitudinally toothed shaft portion 44 is guided in bearing ring 46.

Tool double gripper 50 is mounted to the free end of shaft 42. Gripper 50 supports two semi-circular holders 51, 52, formed like pliers for one respective tool. In FIG. 3 the tool double gripper is rotated by 180° relative to the position shown in FIG. 2.

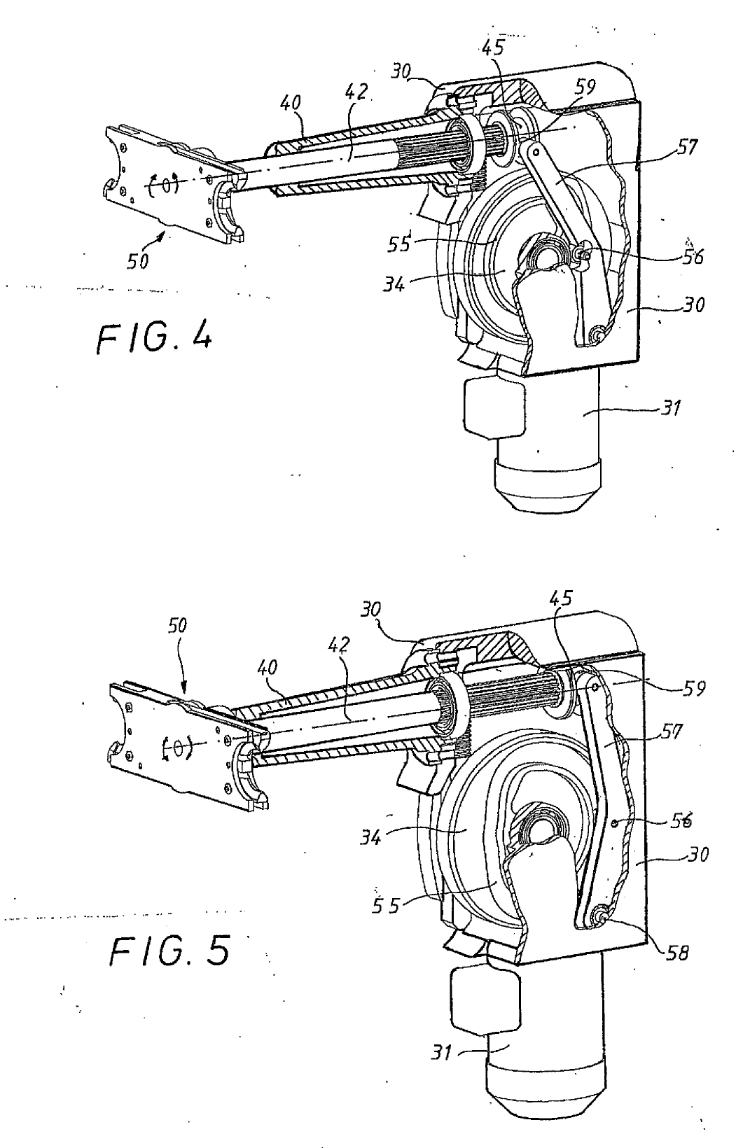

FIGS. 4 and 5 show the opposite side of the tool changer of FIGS. 2, 3, also in a perspective, partially cut away illustration. As can be seen, swivel plate 34 has lifting curve 55 on the second face which is also formed as a groove like the rotation curve 35 on the other face, and is engaged by driver 56. Driver 56 is laterally attached as a pivot or roll to swiveling lever 57 thereby forming a wing, which is formed with an angle and is displaceably supported with its lower end part in a bearing 58 on housing 30. At the upper end of the swiveling lever a driver 59, in the shape of, for example, a rotatably supported roll, is disposed which is engaged between the two radial flanges of end delimiter 45 forming a sleeve. In FIG. 4 swiveling lever 57 is shown in its forward swiveled position in which shaft 42 is moved into its protracted position by the engagement of the driver 59 therewith. In the position shown in FIG. 5, swiveling lever 57 is swiveled to the right and thus shaft 42 as well as the tool double gripper is moved into its retracted position to the right.

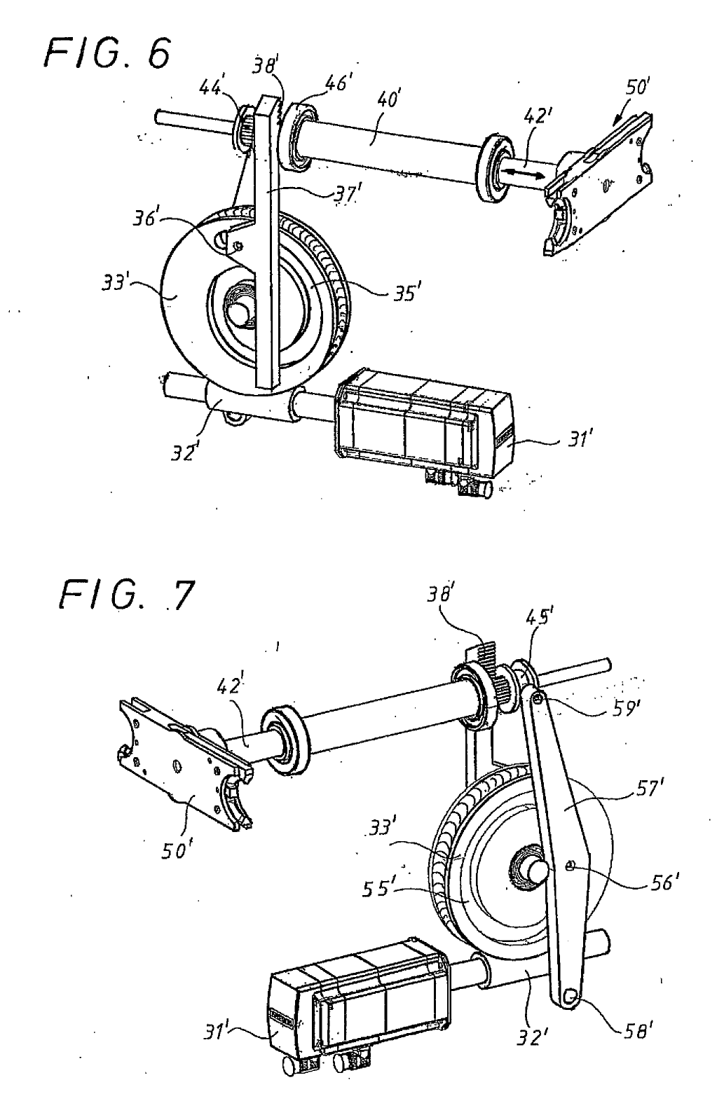

Regarding its technical concept, the embodiment of FIGS. 6 and 7 corresponds to the design described above by referring to FIGS. 2 to 5. For this reason, components having the same function in the embodiment according to FIGS. 6 and 7 are provided with the same reference numeral but including a prime.

The present electric drive motor 31′ is aligned horizontally and drives worm 32′ via its output shaft which, in contrast to the vertical alignment in the first embodiment according to FIGS. 2 to 5, is horizontally aligned. Worm 32′ together with worm wheel 33′ forms a worm gear. The worm wheel is integrally formed with the swivel plate in the embodiment of FIGS. 2 to 5 and carries the teeth on the outer periphery thereof with which it has engaged the teeth of worm 32′.

As can be taken from the one lateral view of FIG. 6, rotation curve 35′ is incorporated in the one face of worm wheel 33′, which is engaged by driver 36′ having, for example, a small roll. Driver 36′ is disposed on swiveling lever 37′ which has a toothed end part 38′, thus forming a rack in the housing (not shown) that can be reciprocated. Toothed portion 38′ engages longitudinally toothed portion 44′ of shaft 42′ supported in cylindrical supporting tube 40′ in an axially displaceable manner, as is also the case in the embodiment according to FIGS. 2 to 5. At the free end of shaft 42′ is mounted tool double gripper 50′ in the same design as in the embodiment according to FIGS. 2 to 5.

FIG. 7 shows the design of the tool changer of FIG. 6 in a schematic perspective illustration from the other side. At the face opposite rotation curve 35′ according to FIG. 6, worm wheel 33′ has lifting curve 55′ in the shape of a molded-in groove which is engaged by driver 56′ fixed to the central broadened part of pivot or swiveling lever 57′. At its lower end, swiveling lever 57 is supported in a swiveling manner in bearing 58′ in the housing (not shown). At its upper end, swiveling lever carries driver 59′ engaging the radial intermediate space of bushing member 45′.

The operating mode of the above-mentioned embodiments is the same to a large extent. By activating the electric motor, the worm of the worm gear is driven, which is formed in a manner mechanically coupled with the swivel plate or integrally formed. When the worm rotates the swivel plate is rotated whereby the drivers engaging the lifting curve on the one hand and the rotation curve on the other hand are moved in accordance with the respective course of the curves. Driver 36, 36′ associated with rack 37, 37′ causes a reciprocating movement of the rack and thus a rotation by 180° of shaft 42, 42′ as well as tool double gripper 50, 50′ about the longitudinal axis. Simultaneously or at a predetermined time lag the engagement of driver 56, 56′ of lifting curve 55, 55′ makes swiveling lever 57, 57′ swivel, whose driver 59, 59′ causes an axial displacement of shaft 42, 42′ and thus also of the tool double gripper.

The invention is not limited to the embodiments as shown. For example, another drive assembly such as a servo motor may be used instead of electric motor 31. Furthermore, linkages may be used for the lifting movement of the shaft and thus of the tool double gripper, which are formed differently as to the structure than pivot or swiveling lever 57.

1-9. (canceled)

10. A tool changer for machine tools, the tool changer comprising:
a housing;
a shaft having a proximal end and a distal end and extending from said housing, said shaft having a longitudinally toothed portion closer to said proximal end than to said distal end;
a tool double gripper connected to said distal end of said shaft, said gripper having two pliers-like tool holders, said shaft with said gripper thereon being rotatable and axially displaceable;
a drive motor having a rotatable motor shaft;
transmission means for converting rotation of said motor shaft into linear and rotary movements of said gripper, said transmission means comprising:
a transmission comprising a worm gear and a worm wheel;
a swivel plate having two sides and being directly driven by said worm wheel, one side of said swivel plate being configured with a lifting curve for the linear movement of said shaft and said gripper, the opposite side of said swivel plate being configured with a rotation curve for the rotary movement of said shaft and said gripper;
a rack and pinion drive rotationally coupled with said shaft and having a first driver which engages said rotation curve, the rack of said rack and pinion drive cooperating with said longitudinally toothed portion of said shaft; and
a pivoting linkage translationally coupled with said shaft and having a second driver which engages and is guided by said lifting curve; and
a supporting tube mounted at an end of said housing and at least in part surrounding said shaft.

11. The tool changer according to claim 10, wherein said worm wheel of said worm gear rotates said shaft of said gripper via said rack and pinion drive and axially displaces said shaft via said lifting curve drive by means of pivoting linkage.

12. The tool changer according to claim 10, wherein a swivel plate associated with the worm wheel of the worm gear has a lifting curve on the one face thereof and a rotation curve on the other face thereof.

13. The tool changer according to claim 11, wherein a swivel plate associated with the worm wheel of the worm gear has a lifting curve on the one face thereof and a rotation curve on the other face thereof.

14. The tool changer according to claim 12, wherein said first driver is disposed at a central cross link of said rack and engages said rotation curve.

15. The tool changer according to claim 13, wherein said first driver is disposed at a central cross link of said rack and engages said rotation curve.

16. The tool changer according to claim 11, wherein said pivoting linkage has a driving member as a linear driver at a distal end thereof, said linear driver engages a collar bushing mounted to said shaft for axially displacing said shaft, a pivot bearing is provided at a proximal end of said pivoting linkage, said second driver being laterally mounted to the central part of said pivoting linkage and engages said lifting curve formed on said swivel plate.

17. The tool changer according to claim 12, wherein said pivoting linkage has a driving member as a linear driver at a distal end thereof, said linear driver engages a collar bushing mounted to said shaft for axially displacing said shaft, a pivot bearing is provided at a proximal end of said pivoting linkage, said second driver being laterally mounted to the central part of said pivoting linkage and engages said lifting curve formed on said swivel plate.

18. The tool changer according to claim 14, wherein said pivoting linkage has a driving member as a linear driver at a distal end thereof, said linear driver engages a collar bushing mounted to said shaft for axially displacing said shaft, a pivot bearing is provided at a proximal end of said pivoting linkage, said second driver being laterally mounted to the central part of said pivoting linkage and engages said lifting curve formed on said swivel plate.

19. The tool changer according to claim 10, wherein said swivel plate is formed as a two-sided cam plate and has on one face thereof said rotation curve and on the other face thereof said lifting curve, each said curve being a milled-in groove.

20. The tool changer according to claim 16, wherein said swivel plate is formed as a two-sided cam plate and has on one face thereof said rotation curve and on the other face thereof said lifting curve, each said curve being a milled-in groove.

21. The tool changer according to claim 19, wherein said worm wheel forms said cam plate that carries the teeth engaging said worm on the outer periphery thereof.

22. The tool changer according to claim 20, wherein said worm wheel forms said cam plate that carries the teeth engaging said worm on the outer periphery thereof.

23. The tool changer according to claim 10, wherein said drive motor is a servo direct drive or a pole-changing three-phase a.c. motor.
